(19) United States
(12) Patent Application Publication
(10) Pub. No.: US 2015/0304824 A1
(43) Pub. Date: Oct. 22, 2015

(54) HANDLING MESSAGES

(71) Applicant: NOKIA CORPORATION, Espoo (FI)

(72) Inventors: Jari Tapani SYRJARINNE, TAMPERE (FI); Juha SALOKANNEL, TAMPERE (FI)

(21) Appl. No.: 14/648,585

(22) PCT Filed: Dec. 7, 2012
(86) PCT No.: PCT/IB2012/057067

§ 371 Date: May 29, 2015

(51) Int. Cl. H04W 4/12; H04W 52/02; H04W 68/02; H04W 4/00

(52) U.S. Cl. CPC H04W 4/12; H04W 4/008; H04W 52/0209; H04W 68/02

(57) ABSTRACT

Apparatus is configured: to generate a sequence of at least first and second messages; to provide the first message in the sequence with sequence data and payload data, the sequence data of the first message indicating that the payload data of the first message is a first part of a sequence of related data; and to provide the second message in the sequence with sequence data and payload data, the sequence data of the second message indicating that the payload data of the second message is a part of the sequence of related data, the part of the sequence of related data being subsequent to the first part of the sequence of related data.

### RELATED DATA

The present application relates to handling messages.

### BACKGROUND

Bluetooth Low Energy (BLE) is a new wireless communication technology published by the Bluetooth SIG as a component of Bluetooth Core Specification Version 4.0. BLE is a lower power, lower complexity, and lower cost wireless communication protocol, designed for applications requiring lower data rates and shorter duty cycles. Inheriting the protocol stack and star topology of classical Bluetooth, BLE redefines the physical layer specification, and involves many new features such as a very-low power idle mode, a simple device discovery, and short data packets, etc.

BLE technology is aimed at devices requiring a low power consumption, for example devices that may operate with one or more button cell batteries such as sensors, key fobs, and/or the like. BLE can also be incorporated into devices such as mobile phones, smart phones, tablet computers, laptop computers, desktop computers etc.

### SUMMARY

Various aspects of examples of the invention are set out in the claims.

A first aspect of the invention provides apparatus configured:
to generate a sequence of at least first and second messages;
to provide the first message in the sequence with sequence data and payload data, the sequence data of the first message indicating that the payload data of the first message is a first part of a sequence of related data; and
to provide the second message in the sequence with sequence data and payload data, the sequence data of the second message indicating that the payload data of the second message is a part of the sequence of related data, the part of the sequence of related data being subsequent to the first part of the sequence of related data.

The apparatus may be configured to provide the first and second messages with data indicating that multi-paging is supported.

The sequence data may consist of one or more bits of one of the messages and the data indicating that multi-paging is supported may consist of one or more different bits of the one of the messages. The apparatus may be configured to provide the sequence data adjacent to the data indicating that multi-paging is supported in each of the messages.

The apparatus may be configured to provide the first and second messages with data indicating a number of sequences of related data that are included in a super-sequence. The apparatus may be configured to provide the first and second messages with data indicating a character type used to code the payload data of the respective messages. The apparatus may be configured to provide the first and second messages with data indicating a language to which the payload data of the respective messages relates. The apparatus may be configured to transmit the sequence of at least first and second messages. The apparatus may be configured to transmit the first and second messages adjacent to one another in the sequence. The apparatus may be configured to transmit the first and second messages separated by a third message.

A second aspect of the invention provides apparatus configured:
to decode a sequence of at least first and second messages, wherein:
   the first message in the sequence includes sequence data and payload data, the sequence data of the first message indicating that the payload data of the first message is a first part of a sequence of related data, and
   the second message in the sequence includes sequence data and payload data, the sequence data of the second message indicating that the payload data of the second message is a part of the sequence of related data, the part of the sequence of related data being subsequent to the first part of the sequence of related data; and
to construct a data sequence comprising the first part of the sequence of related data followed by the second part of the sequence of related data.

The apparatus may be configured to decode from the first and second messages data indicating whether multi-paging is supported, and may be configured to construct the data sequence comprising the first part of the sequence of related data followed by the second part of the sequence of related data only in the event that the data indicating whether multi-paging is supported indicates that multi-paging is supported.

The sequence data may consist of one or more bits of one of the messages and the data indicating that multi-paging is supported may consist of one or more different bits of the one of the messages. The sequence data and the data indicating that multi-paging is supported may be adjacent in each of the messages.

The apparatus may be configured to decode from the first and second messages data indicating a number of sequences of related data that are included in a super-sequence and may be configured to cease receiving messages upon determining that all messages in the super-sequence have been decoded.

The apparatus may be configured to decode from the first and second messages data indicating a character type used to code the payload data of the respective messages, and may be configured to use the indicated character type to construct the data sequence.

The apparatus may be configured to decode from the first and second messages language data indicating a language to which the payload data of the respective messages relates, and may be configured to use the language data to select messages from which to construct the data sequence.

The apparatus may be configured to construct the data sequence using only payload data from messages that include language data indicating that the messages relate to a language that is designated as a supported language by data stored in the apparatus.

The apparatus may further comprise a receiver configured to receive the first and second messages adjacent to one another in the sequence.

The apparatus may further comprise a receiver configured to receive the first and second messages separated by a third message.

A third aspect of the invention provides a method comprising:
generating a sequence of at least first and second messages;
providing the first message in the sequence with sequence data and payload data, the sequence data of the first message indicating that the payload data of the first message is a first part of a sequence of related data; and
providing the second message in the sequence with sequence data and payload data, the sequence data of the second message indicating that the payload data of the second message is a part of the sequence of related data, the part of the sequence of related data being subsequent to the first part of the sequence of related data.

The method may further comprise providing the first and second messages with data indicating that multi-paging is supported.

The sequence data may consist of one or more bits of one of the messages and the data indicating that multi-paging is supported may consist of one or more different bits of the one of the messages.

The method may further comprise providing the sequence data adjacent to the data indicating that multi-paging is supported in each of the messages.

The method may further comprise providing the first and second messages with data indicating a number of sequences of related data that are included in a super-sequence. The method may further comprise providing the first and second messages with data indicating a character type used to code the payload data of the respective messages. The method may further comprise providing the first and second messages with data indicating a language to which the payload data of the respective messages relates. The method may further comprise transmitting the sequence of at least first and second messages. The method may further comprise transmitting the first and second messages adjacent to one another in the sequence. The method may further comprise transmitting the first and second messages separated by a third message.

A fourth aspect of the invention provides a method comprising:
decoding a sequence of at least first and second messages, wherein:
   the first message in the sequence includes sequence data and payload data, the sequence data of the first message indicating that the payload data of the first message is a first part of a sequence of related data, and
   the second message in the sequence includes sequence data and payload data, the sequence data of the second message indicating that the payload data of the second message is a part of the sequence of related data, the part of the sequence of related data being subsequent to the first part of the sequence of related data; and
constructing a data sequence comprising the first part of the sequence of related data followed by the second part of the sequence of related data.

The method may further comprise decoding from the first and second messages data indicating whether multi-paging is supported, and may further comprise constructing the data sequence comprising the first part of the sequence of related data followed by the second part of the sequence of related data only in the event that the data indicating whether multi-paging is supported indicates that multi-paging is supported.

The sequence data may consist of one or more bits of one of the messages and the data indicating that multi-paging is supported may consist of one or more different bits of the one of the messages.

The sequence data and the data indicating that multi-paging is supported may be adjacent in each of the messages.

The method may further comprise decoding from the first and second messages data indicating a number of sequences of related data that are included in a super-sequence and may further comprise ceasing receiving messages upon determining that all messages in the super-sequence have been decoded.

The method may further comprise decoding from the first and second messages data indicating a character type used to code the payload data of the respective messages, and may further comprise using the indicated character type to construct the data sequence.

The method may further comprise decoding from the first and second messages language data indicating a language to which the payload data of the respective messages relates, and may further comprise using the language data to select messages from which to construct the data sequence.

The method may further comprise constructing the data sequence using only payload data from messages that include language data indicating that the messages relate to a language that is designated as a supported language by data stored in the apparatus.

The method may further comprise providing a receiver configured to receive the first and second messages adjacent to one another in the sequence.

The method may further comprise providing a receiver configured to receive the first and second messages separated by a third message.

A fifth aspect of the invention provides a non-transitory computer-readable storage medium having stored thereon computer-readable code, which, when executed by computing apparatus, causes the computing apparatus to perform a method comprising:
generating a sequence of at least first and second messages;
providing the first message in the sequence with sequence data and payload data, the sequence data of the first message indicating that the payload data of the first message is a first part of a sequence of related data; and
providing the second message in the sequence with sequence data and payload data, the sequence data of the second message indicating that the payload data of the second message is a part of the sequence of related data, the part of the sequence of related data being subsequent to the first part of the sequence of related data.

The computer-readable code, when executed by the computing apparatus, may cause the computing apparatus to perform a method comprising providing the first and second messages with data indicating that multi-paging is supported.

The sequence data may consist of one or more bits of one of the messages and the data indicating that multi-paging is supported may consist of one or more different bits of the one of the messages.

The computer-readable code, when executed by the computing apparatus, may cause the computing apparatus to perform a method comprising providing the sequence data adjacent to the data indicating that multi-paging is supported in each of the messages.

The computer-readable code, when executed by the computing apparatus, may cause the computing apparatus to perform a method comprising providing the first and second messages with data indicating a number of sequences of related data that are included in a super-sequence.

The computer-readable code, when executed by the computing apparatus, may cause the computing apparatus to perform a method comprising providing the first and second messages with data indicating a character type used to code the payload data of the respective messages.

The computer-readable code, when executed by the computing apparatus, may cause the computing apparatus to perform a method comprising providing the first and second messages with data indicating a language to which the payload data of the respective messages relates.

The computer-readable code, when executed by the computing apparatus, may cause the computing apparatus to perform a method comprising transmitting the sequence of at least first and second messages.

The computer-readable code, when executed by the computing apparatus, may cause the computing apparatus to perform a method comprising transmitting the first and second messages adjacent to one another in the sequence.

The computer-readable code, when executed by the computing apparatus, may cause the computing apparatus to perform a method comprising transmitting the first and second messages separated by a third message.

A sixth aspect of the invention provides a non-transitory computer-readable storage medium having stored thereon computer-readable code, which, when executed by computing apparatus, causes the computing apparatus to perform a method comprising:
decoding a sequence of at least first and second messages, wherein:
   the first message in the sequence includes sequence data and payload data, the sequence data of the first message indicating that the payload data of the first message is a first part of a sequence of related data, and
   the second message in the sequence includes sequence data and payload data, the sequence data of the second message indicating that the payload data of the second message is a part of the sequence of related data, the part of the sequence of related data being subsequent to the first part of the sequence of related data; and
constructing a data sequence comprising the first part of the sequence of related data followed by the second part of the sequence of related data.

The computer-readable code, when executed by the computing apparatus, may cause the computing apparatus to perform a method comprising decoding from the first and second messages data indicating whether multi-paging is supported, and comprising constructing the data sequence comprising the first part of the sequence of related data followed by the second part of the sequence of related data only in the event that the data indicating whether multi-paging is supported indicates that multi-paging is supported.

The sequence data consists of one or more bits of one of the messages and wherein the data indicating that multi-paging is supported consists of one or more different bits of the one of the messages.

The sequence data and the data indicating that multi-paging is supported are adjacent in each of the messages.

The computer-readable code, when executed by the computing apparatus, may cause the computing apparatus to perform a method comprising decoding from the first and second messages data indicating a number of sequences of related data that are included in a super-sequence and comprising ceasing receiving messages upon determining that all messages in the super-sequence have been decoded.

The computer-readable code, when executed by the computing apparatus, may cause the computing apparatus to perform a method comprising decoding from the first and second messages data indicating a character type used to code the payload data of the respective messages, and comprising using the indicated character type to construct the data sequence.

The computer-readable code, when executed by the computing apparatus, may cause the computing apparatus to perform a method comprising decoding from the first and second messages language data indicating a language to which the payload data of the respective messages relates, and comprising using the language data to select messages from which to construct the data sequence.

The computer-readable code, when executed by the computing apparatus, may cause the computing apparatus to perform a method comprising constructing the data sequence using only payload data from messages that include language data indicating that the messages relate to a language that is designated as a supported language by data stored in the apparatus.

A seventh aspect of the invention provides a computer program comprising instructions that when executed by a computer apparatus control it to perform the method of the third or fourth aspects of the invention.

An eighth aspect of the invention provides an apparatus, the apparatus having at least one processor and at least one memory having computer-readable code stored thereon which when executed controls the at least one processor:
to generate a sequence of at least first and second messages;
to provide the first message in the sequence with sequence data and payload data, the sequence data of the first message indicating that the payload data of the first message is a first part of a sequence of related data; and
to provide the second message in the sequence with sequence data and payload data, the sequence data of the second message indicating that the payload data of the second message is a part of the sequence of related data, the part of the sequence of related data being subsequent to the first part of the sequence of related data.

The computer-readable code stored on the at least one memory, when executed, may control the at least one processor to provide the first and second messages with data indicating that multi-paging is supported.

The sequence data consists of one or more bits of one of the messages and wherein the data indicating that multi-paging is supported consists of one or more different bits of the one of the messages.

The computer-readable code stored on the at least one memory, when executed, may control the at least one processor to provide the sequence data adjacent to the data indicating that multi-paging is supported in each of the messages.

The computer-readable code stored on the at least one memory, when executed, may control the at least one processor to provide the first and second messages with data indicating a number of sequences of related data that are included in a super-sequence.

The computer-readable code stored on the at least one memory, when executed, may control the at least one processor to provide the first and second messages with data indicating a character type used to code the payload data of the respective messages.

The computer-readable code stored on the at least one memory, when executed, may control the at least one processor to provide the first and second messages with data indicating a language to which the payload data of the respective messages relates.

The computer-readable code stored on the at least one memory, when executed, may control the at least one processor to cause transmission of the sequence of at least first and second messages.

The computer-readable code stored on the at least one memory, when executed, may control the at least one processor to cause transmission of the first and second messages adjacent to one another in the sequence.

The computer-readable code stored on the at least one memory, when executed, may control the at least one processor to cause transmission of the first and second messages separated by a third message.

A ninth aspect of the invention provides an apparatus, the apparatus having at least one processor and at least one memory having computer-readable code stored thereon which when executed controls the at least one processor:
to decode a sequence of at least first and second messages, wherein:
   the first message in the sequence includes sequence data and payload data, the sequence data of the first message indicating that the payload data of the first message is a first part of a sequence of related data, and
   the second message in the sequence includes sequence data and payload data, the sequence data of the second message indicating that the payload data of the second message is a part of the sequence of related data, the part of the sequence of related data being subsequent to the first part of the sequence of related data; and
to construct a data sequence comprising the first part of the sequence of related data followed by the second part of the sequence of related data.

The computer-readable code stored on the at least one memory, when executed, may control the at least one processor to decode from the first and second messages data indicating whether multi-paging is supported, and may control the at least one processor to construct the data sequence comprising the first part of the sequence of related data followed by the second part of the sequence of related data only in the event that the data indicating whether multi-paging is supported indicates that multi-paging is supported.

The sequence data may consist of one or more bits of one of the messages and wherein the data indicating that multi-paging is supported may consist of one or more different bits of the one of the messages.

The sequence data and the data indicating that multi-paging is supported may be adjacent in each of the messages.

The computer-readable code stored on the at least one memory, when executed, may control the at least one processor to decode from the first and second messages data indicating a number of sequences of related data that are included in a super-sequence and may control the at least one processor to cease receiving messages upon determining that all messages in the super-sequence have been decoded.

The computer-readable code stored on the at least one memory, when executed, may control the at least one processor to decode from the first and second messages data indicating a character type used to code the payload data of the respective messages, and may control the at least one processor to use the indicated character type to construct the data sequence.

The computer-readable code stored on the at least one memory, when executed, may control the at least one processor to decode from the first and second messages language data indicating a language to which the payload data of the respective messages relates, and may control the at least one processor to use the language data to select messages from which to construct the data sequence.

The computer-readable code stored on the at least one memory, when executed, may control the at least one processor to construct the data sequence using only payload data from messages that include language data indicating that the messages relate to a language that is designated as a supported language by data stored in the apparatus.

Bluetooth Low Energy or BLE as used herein denotes Bluetooth Core Specification Version 4.0 or later versions that are backwards-compatible with Version 4.0 A BLE device or component is a device or component that is compatible with Bluetooth Core Specification Version 4.0.

### BRIEF DESCRIPTION OF THE DRAWINGS

For a more complete understanding of example embodiments of the present invention, reference is now made to the following descriptions taken in connection with the accompanying drawings in which:

FIG. 1 is a schematic diagram of a system according to aspects of the invention including components according to aspects of the invention and operating according to aspects of the invention;

FIG. 2 presents the format of an Advertising Channel PDU used in embodiments of the invention;

FIG. 3 is a flow chart illustrating operation of a beacon of FIG. 1 according to embodiments of the invention;

FIG. 4 shows a format of an octet that may be broadcast during the operation of FIG. 3;

FIG. 5 shows a format of another octet that is broadcast during the operation of FIG. 3;

FIGS. 6 and 7 show alternative sequences for messages that may be broadcast during the operation of FIG. 3; and

FIG. 8 is a flow chart illustrating operation of a mobile device of FIG. 1 according to embodiments of the invention.

### DETAILED DESCRIPTION OF VARIOUS EMBODIMENTS

The following acronyms are used in the specification and have the meanings referred to:

BLE: Bluetooth Low Energy

BT: Bluetooth

BT SIG: Bluetooth Special Interest Group

LE: Low Energy

RFU: Reserved for Future Use

HAIP: High Accuracy Indoor Positioning

BLE technology has been proposed to be used in high accuracy indoor positioning (HAIP) systems. HAIP with BLE uses an array of phased antennas to calculate angle-of-departure or angle-of-arrival of a signal. The principles behind calculating the angle-of-departure or angle-of-arrival are described in the prior art.

There are two main options for positioning a mobile device or beacon in a BLE HAIP system.

In a first option, the mobiles/tags transmit a BLE positioning packet, which is received at a base station (which can be called a locator) including an antenna array. The base station (or some other device) measures the angle-of-arrival (both azimuth and elevation angles) of the signal using samples of the positioning packet received at different elements of the antenna array, and consequently calculates the position of the mobile/tag. This can be called network-centric positioning. The network-centric approach is limited by capacity.

In a second option, a base station includes an antenna array and transmits a BLE positioning packet from different elements of the antenna array in a way that allows the mobile/tag to calculate the angle-of-departure (both azimuth and elevation angles) of the signal from the base station. The base station here can be termed a beacon. This can be termed mobile-centric positioning. The mobile-centric case is advantageous from the capacity point of view as any number of devices can measure and use broadcast signals for positioning purposes.

A base station or beacon may be able to operate according to both options.

It is the mobile-centric option that is of primary interest in the following, although of course a beacon may operate in the mobile-centric mode as well as the network-centric mode.

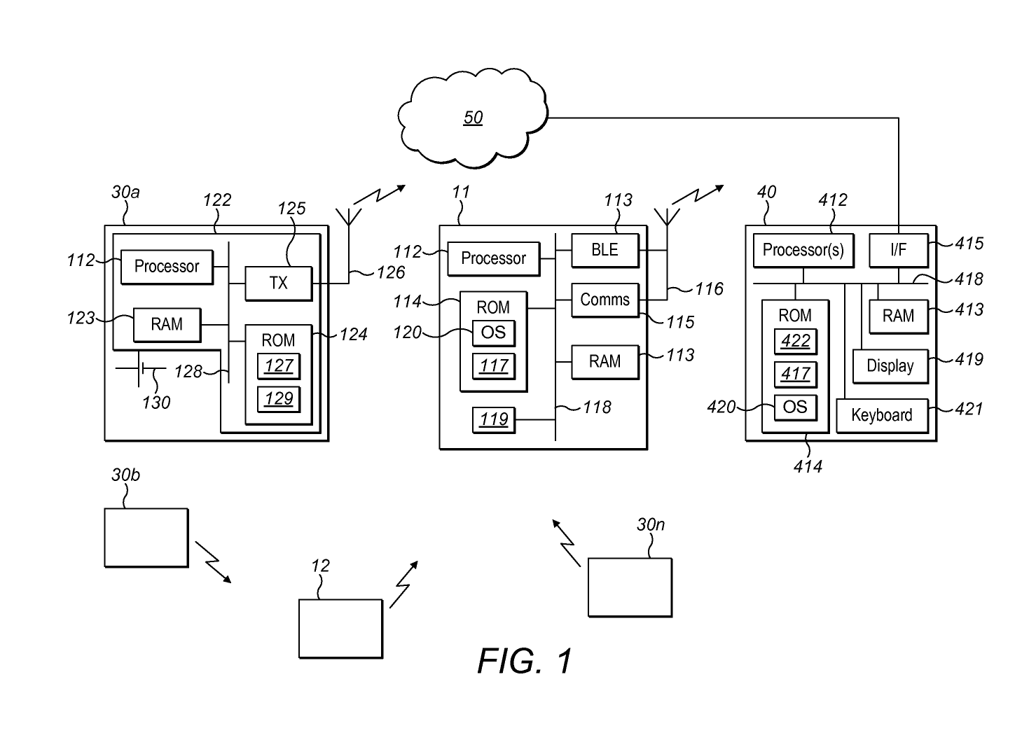

FIG. 1 shows a system according to embodiments of the invention. The system 10 includes a first device 11 and a second device 12. It also includes first to nth BLE beacons 30a, 30b to 30n, each of which may be referred to as a beacon 30. The system also includes a server 40. The first and second devices 11, 12 are mobile or portable and their locations can be tracked.

Briefly, the BLE beacons 30 are based at different locations within a building or complex of buildings and periodically transmit two different messages. These messages are, firstly, AoD positioning packets (or AoD positioning messages) and, secondly, positioning advertisement messages. Both the AoD positioning messages and the positioning advertisement messages transmitted by a given beacon 30 include an identifier that is unique to that beacon 30 within the building.

Each of the BLE beacons 30 includes multiple antenna elements and transmits the AoD positioning packets including a certain packet tail called AoD extension. The beacon has multiple antenna elements which are used sequentially during the transmission of the AoD extension. The sequence of antenna elements involves switching between them in a pre-defined order. Each of the first and second devices 11, 12 is able to receive an AoD positioning packet from the BLE beacons 30 and calculate, from parameters of the received signal at the part corresponding to the AoD extension, a bearing from the beacon 30 at which the AoD positioning packet was received at the device 11, 12. The bearing is able to be calculated because of the form given to the signal transmitted along the bearing by the multiple antenna elements.

The positioning advertisement messages include information designating the location and orientation of the beacon 30. They may be sent from only a single element of the antenna 116. The positioning advertisement messages are received at the devices 11, 12.

Both AoD positioning packets and positioning advertisement messages are transmitted periodically, although the AoD positioning packets are transmitted more frequently.

The devices 11, 12 then can calculate their position using information designating the location and orientation of the beacon and the calculated bearing. Devices 11, 12 can calculate their locations having received an AoD positioning packet from one beacon with a reasonable degree of accuracy. Devices 11, 12 can calculate their locations with greater accuracy by triangulating information relating to AoD positioning packets received from two or more beacons, although the accuracy achieved using only one beacon typically is sufficient. Devices 11, 12 are able to calculate their location without network assistance.

The first device 11 includes a BLE module 13, which operates according to the BLE standard. Each of the BLE beacons 30 also includes a BLE module that operates according to the BLE standard.

The first device 11 includes a processor 112. The processor 112 is connected to volatile memory such as RAM 113 by a bus 118. The bus 118 also connects the processor 112 and the RAM 113 to non-volatile memory, such as ROM 114. A communications interface or module 115 is coupled to the bus 118, and thus also to the processor 112 and the memories 113, 114. A BLE module 13 is coupled to the bus 118, and thus also to the processor 112 and the memories 113, 114. An antenna 116 is coupled to the communications module 115 and the BLE module 13, although each may instead have its own antenna. Within the ROM 114 is stored a software application 117. The software application 117 in these embodiments is a navigation application, although it may take some other form. An operating system (OS) 120 also is stored in the ROM 114.

The first device 11 may take any suitable form. Generally speaking, the first device 11 may comprise processing circuitry 112, including one or more processors, and a storage device 114, 113, comprising a single memory unit or a plurality of memory units. The storage device 114, 113 may store computer program instructions that, when loaded into the processing circuitry 112, control the operation of the first device 11.

The BLE module 13 may take any suitable form. Generally speaking, the BLE module 13 of the first device 11 may comprise processing circuitry, including one or more processors, and a storage device comprising a single memory unit or a plurality of memory units. The storage device may store computer program instructions that, when loaded into the processing circuitry, control the operation of the BLE module 13.

The first device 11 also comprises a number of components which are indicated together at 119. These components 119 may include any suitable combination of a display, a user input interface, other communication interfaces (e.g. wifi, etc.), a speaker, a microphone, and a camera. The components 119 may be arranged in any suitable way.

The BLE module 13 includes a communication stack that is implemented at least partly in software using processor and memory resources (not shown), all of which are included within the BLE module 13. The BLE module 13 is configured, when enabled by the navigation application 117, to calculate the location of the host device 11 as described above, and to report the location to the navigation application 117.

The navigation application 117 is configured to control the BLE module 13 to switch between a positioning mode in which it calculates the position of the host device 11, 12 and a non-positioning mode in which it does not calculate the position of the host device 11, 12, as required by the navigation application 117.

The navigation application 117 may for instance control the BLE module to reside in the positioning mode when positioning has been enabled by the user or by the operating system 120 and when outdoor positioning (e.g. GPS) is unavailable, and to reside in the non-positioning mode otherwise. Alternatively, the navigation application 117 may for instance control the BLE module to reside in the positioning mode when positioning has been enabled by the user or by the operating system 120 and when BLE positioning advertisement messages have been received within a certain time period (e.g. 10 minutes before the current time), and to reside in the non-positioning mode otherwise.

The second device 12 may be configured and operate in the same way as the first device 11.

The devices 11, 12 may be mobile phones, smart phones, tablet computers, laptop computers, cameras, mp3-players, equipment integrated within vehicles, etc. The devices 11, 12 may be based around any suitable operating system, for instance the Symbian operating system or Microsoft Windows operating system, although any other operating system may instead be used. The devices 11, 12 may run different operating systems.

The beacon 30, for instance the first beacon 31a, includes a BLE module 121, an antenna 126 and a source of power 130. In the BLE module 121 of the beacon 30, a processor 122, RAM 123, ROM 124, a transmitter 125, software 127 and a bus 128 are constituted and connected in any suitable way. The ROM 124 of the beacon 30 also stores information 129. The information 129 includes an identifier that identifies the beacon, the location of the beacon, and the orientation of the beacon.

The beacon 30 includes a communication interface 108, using which communications can be received from the server 40. The server 40 may be connected either directly or indirectly with the beacon 30. The server 40 may be connected with the beacon 30 by Ethernet.

The source of power 130 may be for instance a power-over-Ethernet source, a battery, or mains power. The source of power 130 powers the BLE module 121 and any other components of the beacon 30.

The BLE module 121 of the beacon 30 may solely be a transmitter 125 and may not perform receiver functions. The transmitter 125 may include hardware needed for receiving, the receive function being disabled through the software 127. Alternatively, the transmitter 125 may be absent of some of the hardware needed for receiving. Put another way, it may be a transmitter or it may be a transceiver in which the receive functions have been disabled in software.

Each of the BLE beacons 30 includes multiple antenna elements (indicated together at 126 in the Figure) and transmits AoD positioning messages using these multiple antenna elements simultaneously. By transmitting the AoD positioning messages in this way, a device 11, 12 can calculate from parameters of the received signal that included the AoD positioning message an angle (actually, both azimuth and elevation angles) from the beacon 30 at which the device 11, 12 is located.

Each of the BLE beacons 30 also is configured to transmit information designating the location and orientation of the beacon 30. This information forms part of the positioning advertisement messages. As such, devices 11, 12 can calculate their locations having received an AoD positioning packet from one beacon 30 with a reasonable degree of accuracy. Devices 11, 12 can calculate their locations with greater accuracy by triangulating or by combining information relating to AoD positioning message received from two or more beacons, although the accuracy achieved using only one beacon typically is sufficient. Devices 11, 12 are able to calculate their location without network assistance. Additionally, the beacons 30 do not need to receive communications from the devices 11, 12 in order to allow the devices 11, 12 to calculate their positions from the received AoD positioning message.

Positioning advertisement messages may be transmitted by each beacon 30 periodically, for instance at 1 Hz (1 second intervals) or 2 Hz (0.5 second intervals) or at intervals defined by some component within the system. They may alternatively be transmitted on request of some component within the system.

AoD positioning messages may be transmitted by each beacon 30 periodically, for instance at 20 Hz (50 millisecond intervals). Clearly, devices 11, 12 can calculate their positions at the same periodicity, or the devices 11, 12 can filter multiple measurements for better accuracy. Such a frequency of transmission of AoD positioning messages allows rapid and reliable positioning updates for the devices 11, 12.

The beacon 30 may take any suitable form. Generally speaking, the beacon 30 may comprise processing circuitry, including one or more processors, and a storage device, comprising a single memory unit or a plurality of memory units. The storage device may store computer program instructions that, when loaded into the processing circuitry, control the operation of the beacon 30.

The other beacons 30b . . . 30n may be configured and operate in the same way as the first beacon 30a. The other beacons are different to the first beacon 30a at least in that the information 129 stored in the ROM 124 includes a different identifier and a different location, and may also include a different orientation of the beacon.

The server 40 includes a processor 412. The processor 412 is connected to volatile memory such as RAM 413 by a bus 418. The bus 418 also connects the processor 112 and the RAM 413 to non-volatile memory, such as ROM 414. A communications interface 415 is coupled to the bus 418, and thus also to the processor 412 and the memories 413, 414. The interface 415 is connected to the radio network 50 in any suitable way, for instance via the Internet or a local network. Within the ROM 414 is stored a software application 417. An operating system (OS) 420 also is stored in the ROM 414. Within the ROM 414 is also stored a location database 422.

An output device such as a display 419 may be provided with the server 40. An input device such as a keyboard 421 may be provided with the server 40.

The server 40 may take any suitable form. Generally speaking, the server 40 may comprise processing circuitry 412, including one or more processors, and a storage device 413, comprising a single memory unit or a plurality of memory units. The storage device 414, 413 may store computer program instructions that, when loaded into the processing circuitry 412, control the operation of the server 40.

Some further details of components and features and alternatives for them will now be described.

The computer program instructions 117 may provide the logic and routines that enables the first device 11 to perform the functionality described below. The computer program instructions 117 may be pre-programmed into the first device 11. Alternatively, they may arrive at the first device 11 via an electromagnetic carrier signal or be copied from a physical entity such as a computer program product, a non-volatile electronic memory device (e.g. flash memory) or a record medium such as a CD-ROM or DVD. They may for instance be downloaded to the first device 11 from a server, for instance the server 40 but possibly another server such as a server of an application marketplace or store.

The processing circuitry 112, 122, 412 may be any type of processing circuitry. For example, the processing circuitry may be a programmable processor that interprets computer program instructions and processes data. The processing circuitry may include plural programmable processors. Alternatively, the processing circuitry may be, for example, programmable hardware with embedded firmware. The processing circuitry or processor 112, 122, 412 may be termed processing means.

Typically, the BLE modules 13, 121 each comprise a processor coupled connected to both volatile memory and non-volatile memory. The computer program is stored in the non-volatile memory and is executed by the processor using the volatile memory for temporary storage of data or data and instructions.

The term ‘memory’ when used in this specification is intended to relate primarily to memory comprising both non-volatile memory and volatile memory unless the context implies otherwise, although the term may also cover one or more volatile memories only, one or more non-volatile memories only, or one or more volatile memories and one or more non-volatile memories. Examples of volatile memory include RAM, DRAM, SDRAM etc. Examples of non-volatile memory include ROM, PROM, EEPROM, flash memory, optical storage, magnetic storage, etc.

Each BLE module 13, 121 may be a single integrated circuits. Each may alternatively be provided as a set of integrated circuits (i.e. a chipset). The BLE modules 13, 121 may alternatively be hardwired, application-specific integrated circuits (ASIC).

The communication interface 115 may be configured to allow two-way communication with external devices and/or networks. The communication interface may be configured to communicate wirelessly via one or more of several protocols such as Global System for Mobile Communications (GSM), Code Division Multiple Access (CDMA), Universal Mobile Telecommunications System (UMTS) and IEEE 802.11 (Wi-Fi). Alternatively or additionally, the communication interface 115 may be configured for wired communication with a device or network.

The apparatus 11, 12, 40, 30 may comprise further optional software components which are not described in this specification since they may not have direct interaction with the features described.

The BLE beacons 30 are distributed around a building or premises. For instance a first beacon 30a may be located in a canteen, a second beacon 30b may be located in a reception area, and so on. The first and second beacons 30a and 30b can be referred to as beacons 30. Beacons 30 do not need to provide complete coverage of a building, but advantageously are provided to provide good coverage of all key locations within the building.

The beacon identifier transmitted by a beacon 30 may be provided in a Device Address field or in a Device Identifier field of an advertising message, according to the BLE specification, or it may take some other form.

The latest version of the BLE specification defines three advertising channels, which serve for device discovery and other broadcasting purpose. To identify BLE devices, two important identifies—Device Address and Device Name—are highly relied upon. According to the BLE specification, packets sent in the advertising channels (index=37, 38 and 39) shall contain the device addresses, which are used to identify a BLE device. The identifier relating to a beacon may be a device address included in the Device Address field, or it may be included in a payload of the advertising message.

There are two types of device addresses: public device address and random device address, each of them is 48 bits in length. A device shall contain at least one type of device address and may contain both.

### Public Device Address

The content of a public device address contains two fields:
company_assigned field is in the 24 least significant bits
company_id field is in the 24 most significant bits

The public device address shall be created in accordance with section 9.2 (“48-bit universal LAN MAC addresses”) of the IEEE 802-2001 standard (http://standards.ieee.org/getieee802/download/802-2001.pdf) and using a valid Organizationally Unique Identifier (OUI) obtained from the IEEE Registration Authority (see http://standards.ieee.org/regauth/oui/forms/ and sections 9 and 9.1 of the IEEE 802-2001 specification).

### Random Device Address

A random device address is divided into the following two fields:
hash field is in the 24 least significant bits
random field is in the 24 most significant bits

The detailed specification of the hash field and random field can be found in BT Specification v4.0, vol. 3, Part C, Section 10.8.2.3 and Section 10.8.2.2, respectively.

On the other hand, the Generic Access Profile (GAP) also provides a Local Name AD Type to contain the device name in the BLE advertising data (BT Specification v4.0, Vol. 3, Part C, Section 11.1.2).

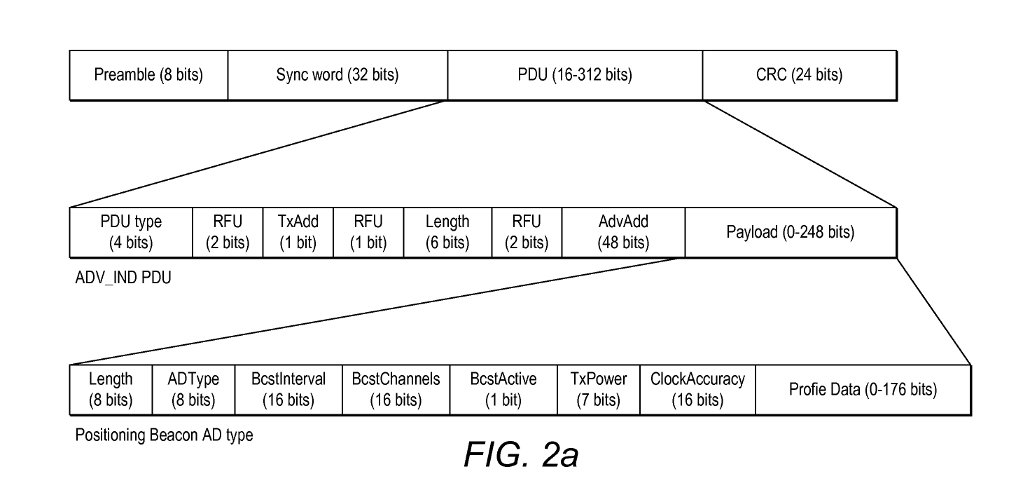

A positioning advertisement message may be a BLE link layer packet, an example of which is shown in FIG. 2. FIG. 2A shows higher level components of the positioning advertisement messages, and FIG. 2B shows some lower level components of the positioning advertisement messages.

As shown in FIG. 2, there are four main components to the message. The first part is a preamble. The second part is a sync word. The third part is a packet data unit (PDU). The fourth part is a cyclic redundancy check (CRC).

Here, the preamble is one octet (eight data bits, also known as one byte). The sync word is four octets. The PDU is between two and 39 octets. The CRC is three octets.

As shown in FIG. 2A, the PDU includes two main sections. The first is the header, and the second is the payload. The header here has 64 bits (six octets). The payload has a length that is between zero and 31 octets, as per the length field in the header part of the PDU.

The header is shown in FIG. 2A as being divided into six fields. The PDU type field comprises four bits, and identifies the type of the PDU. The second field is reserved for future use (RFU) and includes two bits. A TxAdd field is one bit. The fourth field is reserved for future use (RFU) and includes one bit. The Length field includes six bits. The sixth field is reserved for future use (RFU) and includes two bits. An AdvA field (or AdvAdd field) is 6 octets (48 bits).

The TxAdd field indicates whether the address of the beacon 30 in the AdvA field is public or random. The AdvA field includes the public or random address of the beacon 30.

The payload of the PDU, hereafter termed the Positioning Beacon AD Type, includes eight fields. The first of these is a length field, of one octet. The second is an AdType field which is one octet. The AdType field is used for structuring advertising data contents for different purposes. For example, the content may be a list of Service IDs, or just one service ID followed by the data related to that service ID. In these examples, there is a set of parameters that are known by the BLE module 113 of the receiver.

A BestInterval field is two octets long. This indicates the interval between successive Broadcasts. A BcstChannels field is two octets long. This indicates the channels that are used for broadcast. A BcstActive field is one bit long. This bit indicates whether broadcasting is active. A TransmitPower field is seven bits long. The transmit power is indicated in this field. A ClockAccuracy field is sixteen bits long. This includes data that indicates the accuracy of the clock within the beacon 30. Lastly, a Profile Data field is between 0 and 22 octets long, according to the value included in the Length field.

The Positioning Beacon AD Type is shown both FIGS. 2A and 2B, but this is the same in both Figures. FIG. 2B shows in detail the Profile Data field of the Positioning Beacon AD Type.

The Profile Data field of the Positioning Beacon AD Type includes four fields. The first is ServiceID, which is two octets in length. The data included in the ServiceID field is used only by the Host of the BT communications stack. An identifier of the service that is provided by the positioning messages is included in this field. A PageID field is three bits. A PageIDData field is five bits long. Lastly, a Data field is between 0 and 19 octets, according to the data included in the Length field of the Positioning Beacon AD Type.

The Data field constitutes an Antenna Coordinates Global Data part, which is shown at the bottom of FIG. 2B. This includes six fields. The first field is Antenna type, and is four octets in length. The second field is 2D position, and is 8 octets in length. The third field is Height, and is one octet. The fourth field is floor, and is one octet. A fifth field is a 3D orientation field, of three octets. The last field is an Uncertainty field of two octets.

In the Antenna type field is included data that indicates the type of antenna of the beacon 30. This includes an indication of the particular arrangement of antenna elements in the antenna 126. The 2D position field indicates the position of the beacon in two dimensions. The Height field includes data indicating the location of the beacon in the third, height dimension. The Floor field includes data which indicates which floor the beacon is located. The 3D orientation field includes data which indicates the orientation of the beacon 30 in three dimensions. The Uncertainty field includes data that indicates the level of uncertainty of the 2D position data

When using a BLE advertising channel for communicating from the beacon 30 to a device 11, 12, only 39 octets are available for the advertising PDU that is the payload of the positioning advertising messages. This constitutes a significant limitation on the amount of information that can be carried. By constructing the advertising PDU well, real performance advantages can be achieved in a BLE HAIP system. However the PDU positioning advertising message is constructed, though, there may not be sufficient bandwidth to transmit all the information that is desired to be transmitted.

In the PDU shown in FIG. 2, the Profile Data part comprises only up to 176 bits (20 octets), of which two octets are reserved for the ServiceID. This leaves only 18 octets to communicate an actual data payload. Where the data payload is needed to communicate text, such as a name of a location, this can constitute a significant restriction.

Briefly, embodiments of this invention propose a paging method whereby multiple PDUs can be used to communicate different parts of a data sequence. In the case of a text string, the string can be reconstructed by a receiver after receiving all the relevant PDUs. This is achieved by providing PDUs in a sequence, with each PDU including sequence data and payload data. The sequence data of a first message in the sequence indicates that the payload data of the first message is a first part of a sequence of related data, and the sequence data of a second message in the sequence indicates that the payload data of the second message is a part of the sequence of related data, the part of the sequence of related data being subsequent to the first part of the sequence of related data. In the embodiments the messages in the sequence are transmitted in an order corresponding to an order of the content of the payload data in the sequence, although the messages may be transmitted in a different order.

Embodiments of the invention involve also signalling whether multi-paging is supported, signalling a number of sequences that are transmitted (each sequence relating to a different language for instance), signalling a language to which a particular sequence relates, and signalling a coding scheme used for the content in the data payload.

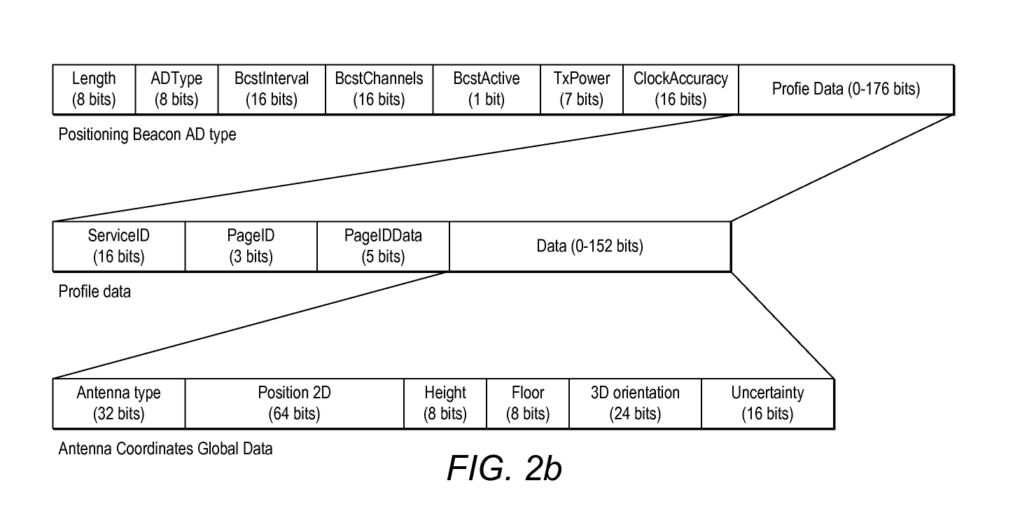

FIG. 3 is a flow chart illustrating operation of the beacon 30.

The operation begins at step S1. At step S2, a sequence number is set to a value of 1. At step S3, a first sequence is selected. A sequence is a text string in one language.

The beacon 30 in these embodiments has a number of text strings to transmit to mobile devices 11, 12. The text strings may for instance be the names of locations, for instance they may each be a name of a location in which the beacon 30 is present. There may be only one sequence, in which the text string is provided in a single language. Alternatively, there may be multiple sequences, each sequence relating to the text string in a different language. Before performing the operation of FIG. 3, the beacon 30 is provided with the text strings that constitute the one or more sequences, as well as an indication of the language to which each text string relates.

At step S4, a UTF coding scheme that is to be used to code the text strings is determined. This may be determined in any suitable way. For instance, it may be determined based on messages received from the server 40. Alternatively, it may be determined based on messages received from the mobile devices 11, 12. Alternatively, it may be determined based on a setting that is provided in the beacon 30, for instance stored in the ROM 214.

At step S5, the beacon 30 determines the language of the sequence that is currently being processed. On the first performance of step S5, the sequence is the first sequence, which was selected at step S3.

At step S6, the beacon 30 determines the number of PDUs that are needed to communicate the text string. The number of PDUs that is needed is a function of the maximum quantity of payload data that can be included in a PDU, the length of the text string (for instance the number of characters included in the text string), and the coding scheme that is to be used to code the text string. In these embodiments, the coding used for the text string is one of the available UTF (UCS Transformation Format) encoding systems. The available options in these embodiments are UTF-8, UTF-16BE and UTF-32, which are merely illustrative.

With UTF, the number of octets that are needed to encode a character of the text string depend on the coding type and the identity of the character. For instance, ASCII characters require only one octet for coding according to UTF-8, but the same character would use two octets when coded under UTF-16.

Step S6 involves determining the minimum number of PDUs that are required to communicate the text string.

At step S7, it is determined whether or not the number of PDUs required to communicate the text string is greater than one. If it is greater than one, that is if multiple PDUs are needed, at step S8 the first PDU is created. This step involves creating the PDU with a Page ID with a value of 101. The MSB (most significant bit) is the leading digit here. The MSB indicates whether multi-paging is enabled in the beacon 30. In this example, a value of 1 indicates that multi-paging is enabled, and a value of o indicates that multi-paging is not enabled. Step S8 involves creating the PDU with the data described above with reference to FIGS. 2A and 2B, although the Data part of the Profile Data of the PDU is not provided with the Antenna Coordinates Global Data part as shown in the bottom of FIG. 2B. Instead, the Profile Data field is as shown in the table below.

| #Octet | Type | Comments |
|---|---|---|
| 0 | Service ID | Fixed |
| 1 | Service ID | Fixed |
| 2 | \|Page ID\|NoLang\|UTF-type\| | Fixed |
| 3 | Language Variant ID | Fixed |
| 4 | UTF-Data | Can be defined freely according to |
| | | the UTF-type |
| . . . | . . . | . . . |
| 19 | UTF-Data | Can be defined freely according to |
| | | the UTF-type |

Here it will be seen that octet number 0 and octet number 1 are reserved for the Service ID. Octet number 2 is reserved for three fields. In particular, these fields include the Page ID. The Page ID field has three bits. A second field is also of three bits. The second field indicates a number of languages that are being transmitted by the beacon. Here the name of the field is truncated to NoLang. The number of languages is equal to the number of sequences, since one language equates to one sequence. Of course, the different sequences need not be used to communicate the same words in different languages, but may instead relate to different sequences for different contexts or different audiences, for instance. A third field comprises two bits. The third field indicates the coding type used to code the text string. This can be called the UTF-type field.

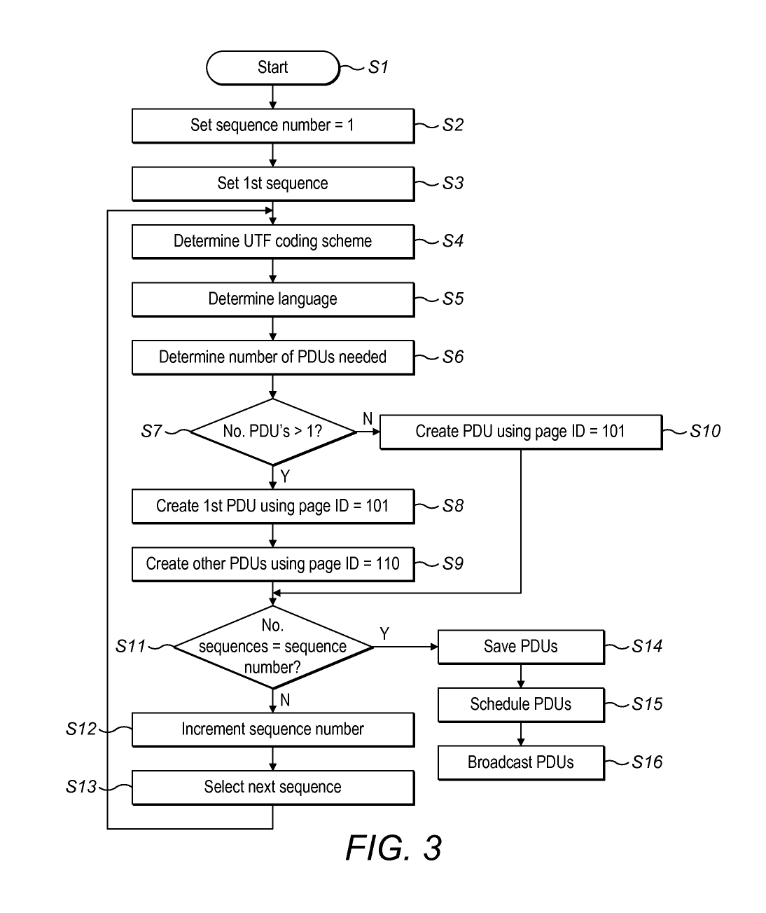

FIG. 4 shows octet number 2 for the situation where the PDU communicates antenna coordinates, or put another way communicates the location of the beacon 30. In FIG. 4, the three MSBs of the octet number 2 form the Page ID field, and the other five bits relate to general data.

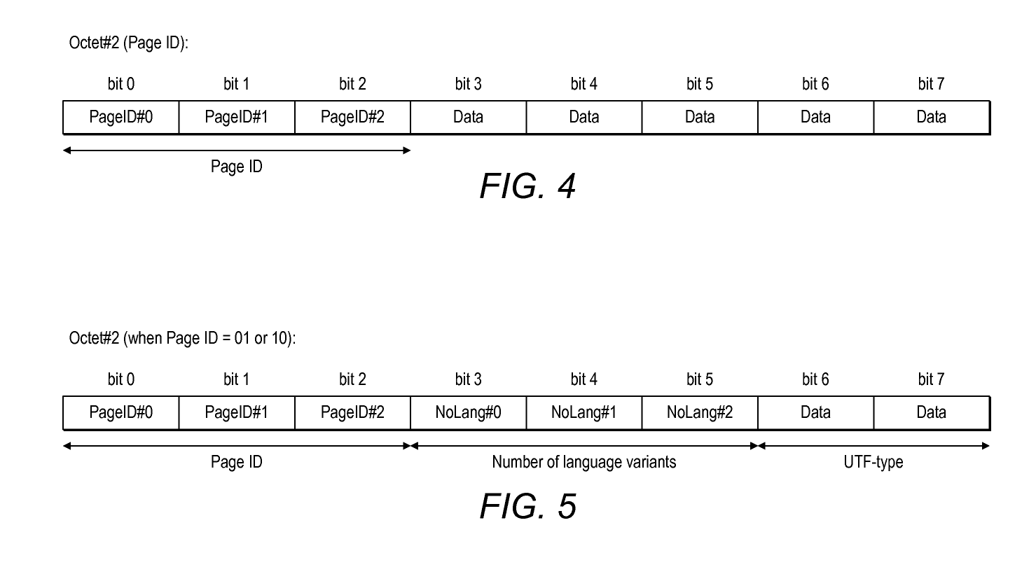

FIG. 5 shows octet number 2 in the case where the PDU relates to location data. The presence of location data in the PDU is indicated by the LSBs of the page ID field having the value 01 or 10, as described above. In FIG. 5, the Page ID field forms the three MSBs of the octet. The number of languages field forms the three middle bits of the octet. The two LSBs of the octet comprise the UTF-type field.

As mentioned above, the MSB of the Page ID field indicates whether multi-paging is supported. The other two bits of the page ID field and the bits of the UTF-type field have meanings as follows.

### PageID:

00=Antenna coordinates (local, global or both)
01=Location data, starting page (contextual location information)
10=Location data, linked page (contextual location information, linked)
n=Reserved for future use

### UTF-Type:

00=UTF-8
01=UTF-16BE
10=UTF-32
11=reserved for future use

A value of 01 for the LSBs of the Page ID field indicates that the PDU communicates location data (that is, a text string) and that the PDU is a starting page, i.e. is the first page in a sequence. A value of 10 for the LSBs of the Page ID field indicates that the

PDU relates to location data and that it is a linked page, that is it is a part of the sequence that is not the first part of the sequence.

A value of 11 for the LSBs of the Page ID field is reserved for future use (RFU).

A value of 00 indicates that the PDU includes antenna coordinates, which is another term for the location of the beacon 30. The antenna coordinates can be indicated in a local coordinate field, a global coordinate field, or both. The communication of antenna coordinates is outside the scope of this explanation. Briefly, however, antenna coordinates are communicated as shown in the Antenna Coordinates Global Data part of the PDU as shown at the bottom of FIG. 2B.

It will be appreciated that the values of the data in the Page ID field that are used to denote the first page in a sequence and a subsequent page in a sequence are illustrative, and that other values may be used instead. Since there are only two options (the start of a sequence and not the start of a sequence), it is possible to communicate the same information using only one bit of the Page ID field. In other implementations, one value may be allocated to identifying the last page in a sequence, which may simplify operation at the receiver.

In these embodiments, the Page ID field includes three bits. The MSB, as mentioned, indicates whether multi-paging is supported. This bit is adjacent bits that indicate whether payload data of the PDU is a first part of a sequence or is not a first part of a sequence.

The Page ID field is adjacent to the number of languages NoLang field. The UTF-type field is adjacent to the number of languages NoLang field.

As can be seen from the above, the coding type used is indicated by the data in the UTF-type field. A value of 00 indicates UTF-8. A value of 01 indicates UTF-16BE. A value of 10 indicates UTF-32. A value of 11 is currently RFU. Clearly, alternative values may be used instead to denote different coding schemes.

The number of languages field includes three bits, so can take any of eight different values. As such, up to eight different languages may be supported, through transmission of eight different sequences of text strings. In these embodiments, the number of languages can be indicated in any suitable way. For instance, a value of 001 may indicate that one language is present. A value of 010 can indicate that two languages are present. Instead of different languages, there may simply be different text strings. For instance, different text strings in a language may be aimed at different demographics, for instance young versus old, novice versus expert, etc, or for different contexts.

As can be seen from the table above, the Page ID field, the number of languages NoLang field and the UTF-type field form different parts of the octet number 2.

Octet number 3 is reserved for indicating the language, and is called the Language Variant ID field. The Language Variant ID field has eight bits. This allows 256 different language variants, covering the majority of the world's most common languages. The mapping between the values in the Language Variant ID field and languages is provided by the Bluetooth SIG Organisation as a pre-defined list, and a part of that list is provided below.
00000000=Default (e.g. for the emergency services)
00000001=English
00000010=Spanish
00000011=Finnish
00000100=Swedish
00000101=French
etc.

The beacon 30 is configured such that the value in the Language Variant ID field is the same for each PDU relating to a particular sequence.

The default language (denoted by Language Variant ID value of 00000000) is provided to applications ignoring language settings. This can be useful for instance with emergency services, where the text string may indicate the name of the exit location.

Octets numbered 4 to 19 contain the actual contextual location information data. This is provided as UTF characters, depending on the UTF type that is defined in octet number 2.

In the first PDU, that is created at step S8, the first part of the text string is encoded into the relevant UTF format and included in the data payload section of the Profile Data part. The number of octets of data may be less than the maximum permitted if for instance multiple octets needed to denote a character would be split over multiple PDUs.

At step S9, the other PDUs forming part of the sequence are created. These are created using a value in the Page ID field that indicates that they are not the first PDU in the sequence. Where the sequence includes only two PDUs, then step S9 includes creating only one other PDU. Where the sequence includes more than two PDUs, step S9 involves creating two or more PDUs. The PDUs are created in the same way as described above with reference to step S8, although as mentioned the value in the Page ID field is different.

Where the PDUs relate to the same sequence, the PDUs are provided with the same data value in the number of languages field and the data in the UTF-type field.

Following step S9, the number of sequences that the beacon is required to broadcast is compared to the sequence number. The sequence number was set at a value of 1 at step S2, and if it has not been incremented then the sequence number at step S11 is 1. If the number of sequences, that is the number of languages for which there is a text string to be transmitted, is equal to the sequence number, it can be inferred that all of the sequences have been dealt with, in the sense that PDUs have been created for all the sequences. A negative determination indicates that PDUs need to be created for other sequences.

If at step S7 it is determined that there is only one PDU needed to communicate the text string, at step S10 a PDU is created. This involves creating the PDU in the same manner as described with reference to step S8. Since the PDU is the only PDU in the sequence, the Page ID field is provided with the value 101, indicating that multi-paging is enabled and that the PDU is the first PDU in the sequence.

On a negative determination from step S11, the sequence number is incremented at step S12. Then, at step S13, the next sequence is selected. After step S13, the operation returns to step S4. Thereafter, the PDU creation process at steps S4 to S10 is repeated for the next sequence. If the next sequence has a different language, so the data in the Language Variant ID field is different. The next sequence will usually have a different language, but it may not. The next sequence may also use a different UTF coding scheme, so the data in the UTF-type field may also be different. The next sequence may have the same language as the previous sequence but use a different UTF coding scheme. It is possible also that the next sequence requires a different number of PDUs. In some circumstances, a text string in one language may require only one PDU and the corresponding text string in another language may require two or more PDUs, depending on differences in the language and on the UTF coding scheme used.

Once step S11 yields a positive determination, so when all of the sequences have been processed, at step S14 the PDUs are saved. The PDUs may for instance be saved in the ROM 214.

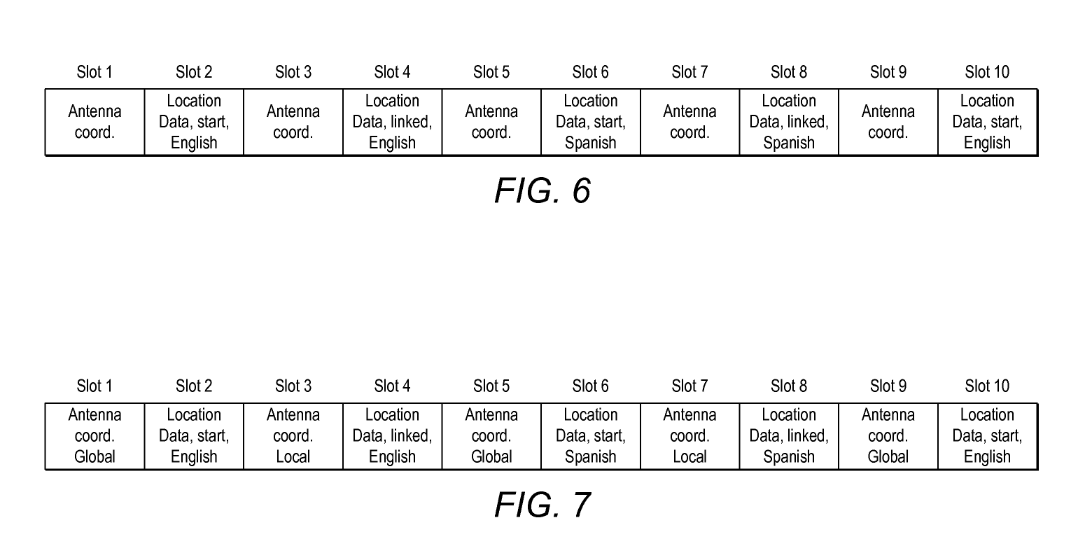

Following saving the PDUs, scheduling of PDUs is formed at step S15. The PDUs may be scheduled in any suitable way, and one possible way of scheduling will now be described with reference to FIGS. 6 and 7.

FIG. 6 shows a sequence of positioning advertisement messages, each including a different PDU. The sequence comprises ten slots, labelled slot 1 to slot 10. Antenna coordinates, relating to the location of the beacon 30, are transmitted relatively frequently by the beacon 30. A desirable effect of this is to reduce the maximum time to first fix, which is the longest period of time that a mobile device 11, 12 could need to obtain the information it needs from signals transmitted from the beacon 30 in order to calculate the position of the mobile device 11, 12. In FIG. 6, the antenna coordinates are shown as being transmitted every other slot, that is in slots 1, 3, 5 etc.

Interleaved between the antenna coordinate slots are slots in which positioning advertisement messages containing location data text are transmitted. The schedule is created by the beacon 30 such as to transmit a first PDU relating to the location data (that is, name of the location) in English in slot 2, with the remainder of the location data in English being transmitted in slot 4. In this example, the beacon 30 required two PDUs in order to transmit the location data in English. At slot 6, the beacon 30 transmits a first PDU in a sequence in which the location data is provided in the Spanish language. The rest of the sequence is transmitted by the beacon 30 in slot 8.

As such, the sequence here comprises eight positioning advertisement messages, each including a respective PDU, which are transmitted from slot 1 to slot 8. Four of these positioning advertisement messages are antenna coordinate messages, which are transmitted in slots 1, 3, 5 and 7. Another two of the messages relate to the location data in a first language, in this example English, and another two of the messages relate to the location data in a second language, in this instance Spanish. The sequence is then commenced again, beginning in slot 9.

Scheduling the PDUs in this way allows the location data to be received at a mobile device 11, 12 even though the location data is too long to be included in a single PDU.

Moreover, the location data is provided in two different languages, allowing the name of the location to be provided to a user of the mobile device 11, 12 in a language that is likely to be more convenient for them than if just one language were used. Moreover, the location data is provided to the mobile devices 11, 12 in such a way that the maximum time to fix a location is not reduced significantly compared to the situation in which the antenna coordinates are transmitted at every slot in the sequence. It will be appreciated that the antenna coordinates are given higher priority than the location data in the sequence, which in most cases is likely to be appropriate because in most instances the mobile devices 11, 12 and the users will be more interested in knowing their location quickly than in knowing the name of the location quickly.

The schedule provided in FIG. 7 is similar to that provided in FIG. 6. The difference is that the antenna coordinates are provided in two different coordinate frames. The beacon 30 is configured to schedule the PDU such that the antenna coordinates are provided in a first coordinate frame, here a global coordinate frame, in slots 1, 5, 9 etc and in a second coordinate frame, here a local coordinate frame, in slots 3, 7, etc. Providing PDUs for the antenna coordinates in different coordinate frames increases the likelihood that a mobile device 11, 12 will receive the antenna coordinates in a form that is usable, or more easily usable, by that device 11, 12.

After scheduling the PDUs at step S15, the PDUs are broadcast by the beacon 30 at step S16.

The beacon 30 may be configured with data for broadcast in any suitable way.

For instance, the beacon 30 may be configured with data by the server 40, for instance through an Ethernet connection.

It may alternatively be configured to create PDUs with data provided by an operator connected to the beacon 30 through a portable device, such as a tablet computer or some other portable device 11. Access may be through a secured wireless connection. Access may be dependent on operator authentication, for instance by requiring a password. Configuration may occur through the device 11 being provided with a configuration software application or through a web interface, for instance.

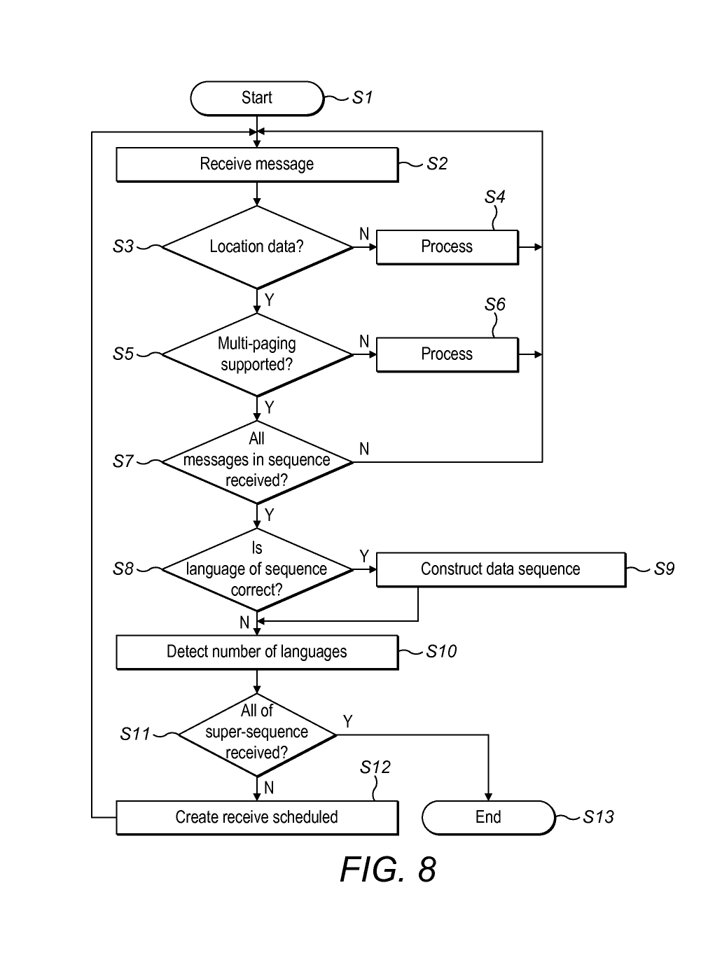

Operation of a mobile device, such as the mobile device 11, will now be described with reference to FIG. 8.

The operation begins at step S1. At step S2, a positioning advertisement message is received from the beacon 30. At step S3, the mobile device 11 determines whether the positioning advertisement message relates to location data, for instance as is shown in one of the even number slots in FIGS. 6 and 7. On a negative determination, which can occur for instance if the positioning advertisement message relates to antenna coordinates data, the message is processed at step S4, before the operation returns to step S2.

After receiving the message at step S2, the positioning advertisement message is decoded by the mobile device. Decoding can be said to be performed by a message decoder, which forms part of the BLE module 113. Message decoding involves the use of hardware and software, or may be implemented purely in software or may alternatively be implemented purely in hardware.

Following a positive determination from step S3, at step S5 it is determined whether multi-paging is supported. This involves examining the data included in the MSB of the page ID field of the PDU of the received positioning advertisement message. It is this bit of the PDU that indicates whether multi-paging is enabled in the beacon 30. In this example, a value of 1 indicates that multi-paging is supported, and a value of o indicates that it is not. On a negative determination from step S5, the received positioning advertisement message is processed at step S6, following which the operation returns to step S2.

On a positive determination from step S5, i.e. on a determination by the mobile device 11 that multi-paging is implemented by the beacon 30, at step S7 it is determined by the mobile device 11 whether all messages in the sequence have been received. This step involves examining the data included in the LSBs of the Page ID field, to determine whether the messages are the first in a sequence or are not the first in a sequence. It also involves examining data included in the octet number 3, which indicates the language to which the sequence relates. The mobile device 11 can determine that all messages in the sequence have been received once the mobile device 11 has detected that a PDU relating to the language of the sequence and having data in the Page ID field indicating that it is the first PDU in the sequence has been received, and also that either the first message in a sequence relating to a different language or a second copy of the PDU relating to the first in the sequence of the same language has been received. Upon such determination, it can be derived that all messages in a sequence have been received at the mobile device 11. Unless this can be derived, the operation returns to step S2.

If it can be derived, a positive determination results from step S7, and the operation proceeds to step S8. At this step, it is determined whether the language of the sequence is correct. This involves the mobile device 11 comparing the language to which the sequence relates, as can be determined from the data in the language variant ID field, to a list of languages stored in the mobile device 11 that are known to be acceptable, or correct, languages. The list of acceptable (correct) languages may have been set by a user of the mobile device, or by the operating system or an application, for instance. The list may include only one language, for instance English, or it may include multiple languages if the user is proficient in multiple languages. If data stored in the mobile device 11 indicates that multiple languages are supported but that one language is preferred, the mobile device may be configured to use the sequence of PDUs relating to a less preferred language only if a sequence of PDUs relating to a more preferred language is not being transmitted by the beacon 30.

If step S8 yields the determination that the language of the sequence is correct, the data sequence is constructed at step S9. Step S9 involves the mobile device 11 decoding the payload data of the PDUs according to the UTF code that has been used, as can be determined by the mobile device 11 by examining the data in the UTF-Type field of the PDUs, and placing the different parts of the sequence of related data together.

Step S9, namely constructing the data sequence, is performed by a data constructor function of the mobile device 11. This may be provided by software, for instance firmware that forms part of the BLE module 113. The data constructor may instead take any other form, and may be implemented solely in hardware, solely in software, or in a combination of hardware and software. The data constructor may be included in the BLE module 113, or it may form part of the device 11 other than the BLE module 113.

Following a negative determination at step S8 or following step S9, the number of languages that are provided in the sequence of messages transmitted by the beacon 30 is detected at step S10. This involves the mobile device 11 examining the data that is in octet number 2, in particular by examining the three bits in the middle of the octet that indicate the number of languages.

Following step S10, the mobile device 11 determines at step S11 whether all of the super sequence has been received. The super sequence here refers to the combination of all of the sequences that are transmitted by the beacon 30. The mobile device 11 is able to determine whether all of the super sequence has been received by determining whether step S7 has yielded a positive determination for all of the languages that were detected at step S10. On a negative determination, it is inferred by the mobile device that the sequences of one or more other languages are required to be received. As such, on a negative determination, the operation proceeds to step S12.

At step S12, a received schedule is created by the mobile device 11. The schedule so created by the mobile device 11 is such as to minimise power consumption of the mobile device whilst allowing the mobile device 11 to receive the PDUs that are needed. For instance, the mobile device 11 may create the received schedule at step S12 such as not to receive PDUs that relate to antenna coordinates that are not needed by the mobile device 11, for instance because they have already been received. With reference to FIG. 7, for instance, the mobile device 11 may at step S12 after having received the location data PDUs in English in slots 2 and 4) create a schedule such as not to receive the antenna coordinates that are transmitted in slots 5, 7, 9 etc. By creating a schedule at step S12 that does not receive all positioning advertisement messages, power consumption in the mobile device 11 can be reduced.

Following step S12, the operation returns to step S2.

When the mobile device 11 determines at step S11 that all of the super sequence has been received, the operation ends at step S13. Once the operation ends, no further positioning advertisement messages are received from the beacon 30. However, if messages from a different beacon 30 are detected, the operation of FIG. 8 may be performed in respect of the other beacon (or beacons).

A number of alternatives to the operation shown in FIG. 8 will be apparent. Some of these will now be described.

Instead of the operation requiring the mobile device 11 to receive all of the messages in a given sequence, in alternative implementations the mobile device 11 may be configured to create a receive schedule such that PDUs relating to languages that are not supported by or are not required by the mobile device 11 are not received. This may involve receiving only part of a sequence of PDUs relating to a given language. Alternatively, if the mobile device 11 is able to determine slots in which PDUs for a sequence relating to a language that is not of interest will be transmitted, the mobile device 11 may create a schedule such as not to receive any of the positioning advertisement messages including those PDUs.

It will be appreciated that the features of the above-described embodiments give rise to a number of effects. They enable a beacon 30 to broadcast antenna coordinates and contextual location information in a very bandwidth limited advertising channel.

They also provide support for multiple languages in the broadcast.

They also provide support for multiple character coding types, for instance UTF types.

Moreover, contextual location information can be provided for relatively long words or word combinations, ones that are too long to be included within a single positioning advertisement message.

Use of the invention does increase the complexity and the implementation of the beacons 30, for the reason that the data needs to be scheduled in the advertising channel. It also slightly increases the complexity of the mobile device 11, in that it needs to be additionally programmed to handle messages where multi-paging etc is enabled. However, the additional complexity is likely in most instances to be provided solely by software or firmware changes.

The provision of contextual location information also increases the interval between successive transmissions of positioning advertisement messages that include antenna coordinates, increasing the maximum time to first position fix for mobile devices.

In this specification, the term advertisement message is used to describe a message that advertises a service. In the main embodiments, the advertisement messages are transmitted on the advertisement channels of the BT specification version 40.

However, the advertisement messages may instead be transmitted on advertisement channels of other versions of the BT specification, both existent and future. Less preferably, the advertisement messages may be transmitted on advertisement channels of existent versions of the BT specification, i.e. version 4.0 and earlier, and later versions of the BT specification that are back-compatible with version 4.0 or an earlier version.

It will be appreciated that the above-described embodiments are not limiting on the scope of the invention, which is defined by the appended claims and their alternatives. Various alternative implementations will be envisaged by the skilled person, and all such alternatives are intended to be within the scope of the claims. A number of alternatives will now be described.

Although it is described above that the beacon 30 creates the PDUs that form part of the positioning advertisement messages, this step may be performed instead by the server 40. In this case, the PDUs are created by the server 40 and sent to the beacon 30, from where they are incorporated in positioning advertisement messages and broadcast. The server 40 thus causes the beacon 30 to transmit the PDUs. Here, the beacons 30 do not need to store information concerning their location orientation etc. other than by storing the PDU received from the server 40. However, the location of the beacon 30 does need to be known by the server 40.

Although in the above the AoD positioning packets and the positioning advertisement messages are separate, they may instead be combined. For instance, an AoD tail can be added to a positioning advertisement message, allowing a mobile device 11, 12 to determine its position after having received only one message from a beacon. However, the inclusion of the AoD tail limits the number of bits available for communicating the other information needed by the mobile devices 11, 12.

Although in the above the positioning advertisement messages are transmitted on BLE advertising channels, it will be appreciated that the information communicated to the mobile devices 11, 12 in the positioning advertisement messages need not be communicated in this way. For instance, the positioning advertisement messages may be broadcast on one or more BLE data channels.

Indeed, the invention is not limited to BLE. It will be appreciated that the concept underlying the above-described embodiments, as defined in the claims, is applicable to other systems in which the same considerations (e.g. limited bandwidth, positioning resolution etc.) are applicable. Other systems to which the invention may be applied and which are intended to be covered by the claims include unidirectional and bidirectional systems both present and future. Systems to which the invention may be applied include WiFi systems, pseudolite-based systems and such like.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer.

A computer-readable medium may comprise a computer-readable storage medium that may be any tangible media or means that can contain or store the instructions for use by or in connection with an instruction execution system, apparatus, or device, such as a computer as defined previously.

According to various embodiments of the previous aspect of the present invention, the computer program according to any of the above aspects, may be implemented in a computer program product comprising a tangible computer-readable medium bearing computer program code embodied therein which can be used with the processor for the implementation of the functions described above.

Reference to “computer-readable storage medium”, “computer program product”, “tangibly embodied computer program” etc, or a “processor” or “processing circuit” etc. should be understood to encompass not only computers having differing architectures such as single/multi processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

1-77. (canceled)

78. Apparatus, the apparatus having at least one processor and at least one memory having computer-readable code stored thereon which when executed controls the at least one processor:
to decode a sequence of at least first and second messages, wherein:
the first message in the sequence includes sequence data and payload data, the sequence data of the first message indicating that the payload data of the first message is a first part of a sequence of related data, and
the second message in the sequence includes sequence data and payload data, the sequence data of the second message indicating that the payload data of the second message is a part of the sequence of related data, the part of the sequence of related data being subsequent to the first part of the sequence of related data; and
to construct a data sequence comprising the first part of the sequence of related data followed by the second part of the sequence of related data.

79. Apparatus as claimed in claim 78, wherein the computer-readable code stored on the at least one memory, when executed, controls the at least one processor to decode the first and second messages data to determine whether multi-paging is supported, and only if multi-paging is determined to be supported, controls the at least one processor to construct the data sequence comprising the first part of the sequence of related data followed by the second part of the sequence of related data.

80. Apparatus as claimed in claim 79, wherein the sequence data consists of one or more bits of one of the messages and wherein the data indicating that multi-paging is supported consists of one or more different bits of the one of the messages.

81. Apparatus as claimed in claim 78, wherein the computer-readable code stored on the at least one memory, when executed, controls the at least one processor to decode from the first and second messages data indicating a number of sequences of related data that are included in a super-sequence and upon determining that all messages in the super-sequence have been decoded to cease receiving messages.

82. Apparatus as claimed in claim 78, wherein the computer-readable code stored on the at least one memory, when executed, controls the at least one processor to decode from the first and second messages language data indicating a language to which the payload data of the respective messages relates, and to select messages to use the correct language data from which to construct the data sequence.

83. Apparatus as claimed in claims 78, comprising providing the first and second messages with data indicating a character type used to code the payload data of the respective messages.

84. Apparatus as claimed in claim 78, wherein the computer-readable code stored on the at least one memory, when executed, controls the at least one processor to decode the first and second messages with data indicating a character type used to code the payload data of the respective messages.

85. Apparatus, the apparatus having at least one processor and at least one memory having computer-readable code stored thereon which when executed controls the at least one processor:
to generate a sequence of at least first and second messages;
to provide the first message in the sequence with sequence data and payload data, the sequence data of the first message indicating that the payload data of the first message is a first part of a sequence of related data; and
to provide the second message in the sequence with sequence data and payload data, the sequence data of the second message indicating that the payload data of the second message is a part of the sequence of related data, the part of the sequence of related data being subsequent to the first part of the sequence of related data.

86. Apparatus as claimed in claim 85, wherein the computer-readable code which when executed controls the at least one processor:
to generate the first and second messages with data indicating that multi-paging is supported.

87. Apparatus as claimed in claim 85, wherein the computer-readable code which when executed controls the at least one processor:
to generate the first and second messages with data indicating a character type used to code the payload data of the respective messages.

88. Apparatus as claimed in claim 85, wherein the computer-readable code which when executed controls the at least one processor:
to generate the first and second messages with data indicating a language to which the payload data of the respective messages relates.

89. A method comprising:
generating a sequence of at least first and second messages;
providing the first message in the sequence with sequence data and payload data, the sequence data of the first message indicating that the payload data of the first message is a first part of a sequence of related data; and
providing the second message in the sequence with sequence data and payload data, the sequence data of the second message indicating that the payload data of the second message is a part of the sequence of related data, the part of the sequence of related data being subsequent to the first part of the sequence of related data.

90. A method as claimed in claim 89, comprising providing the first and second messages with data indicating that multi-paging is supported.

91. A method as claimed in claims 89, comprising providing the first and second messages with data indicating a character type used to code the payload data of the respective messages.

92. A method as claimed in any of claims 89, comprising providing the first and second messages with data indicating a language to which the payload data of the respective messages relates.

93. A method as claimed in any of claims 89, comprising transmitting the sequence of at least first and second messages.
